(19) United States
(12) Patent Application Publication
(10) Pub. No.: US 2006/0073328 A1
(43) Pub. Date: Apr. 6, 2006

(54) Strapping system with non-elastic cohesive tape

(75) Inventors: Thomas S. Murphy, Boxford, MA (US); Ron O'Neil, Wrentham, MA (US)

Correspondence Address: WILMER CUTLER PICKERING HALE AND DORR LLP, 60 STATE STREET, BOSTON, MA, 02109, US

(73) Assignee: Andover Coated Products, Inc.

(21) Appl. No.: 11/231,696

(22) Filed: Sep. 21, 2005

Related U.S. Application Data
(60) Provisional application No. 60/611,662, filed on Sep. 21, 2004.

(51) Int. Cl. B32B 7/12; B32B 15/04

(52) U.S. Cl. 428/355 AC

(57) ABSTRACT

A strapping system for securing a human or animal body part is provided that includes an elastic cohesive layer of underwrap and a non-elastic cohesive layer of overwrap. A strapping system kit including the components of the strapping system, and a method of applying the strapping system to a human or animal body part is further provided.

### CROSS REFERENCE TO RELATED APPLICATIONS

This Application claims the benefit of priority to U.S. Provisional Application No. 60/611,662, filed Sep. 21, 2004, the contents of which are incorporated by reference herein in their entirety.

### FIELD OF THE INVENTION

The invention is in the field of orthopedic and sports medicine. More specifically, the invention relates to a two-component strapping system useful in limiting the range of motion of a joint to prevent injury or facilitate safe use of an injured body part. In particular, the invention relates to a two-layer strapping system employing an elastic cohesive tape layer and a non-elastic cohesive tape layer.

### BACKGROUND OF THE INVENTION

Taping of ankles, knees and elbows is widely used in sports and orthopedic medicine to prevent injury or to protect existing injuries by limiting abnormal or excessive movement and by providing mechanical support to underlying muscles. In the past, adhesive tapes were applied directly to the subject's skin, however direct adhesion of the tape to skin and hair make removal difficult and often injurious to the subject. In addition, adhesive tapes applied directly to the skin would frequently loosen and lose their effectiveness with continued use due to exposure to exercise-associated sweat and mechanical strain. Later, gauze underwraps were added to the adhesive tape system to prevent injury to the skin caused by direct contact with adhesive tape. However the gauze underwrap was frequently difficult to work with and did not conform well to either the site of application or to the overlying adhesive tape layer to provide a tight, compact and coherent fit. Still later, foam rubber underwraps, with improved conformability over gauze underwraps, were employed. However, such foam underwraps do not always provide an adequately flexible fit to conform over all body parts, and, further, do not always join securely with the overlaying adhesive tape to provide a long-lasting orthopedic support system. In addition foam underwraps are known to become unsecured during athletic performance due to sweat and mechanical stress. Therefore, each of these approaches to athletic or orthopedic taping suffers from one or more shortcomings in comfort and/or performance.

Accordingly, it would be desirable to provide a method of taping, i.e. a strapping system, that provides a secure, comfortable, easily removable, well-conformed, and perspiration and motion-resistant strapping system for supporting a human or animal body part. It would further be desirable for the strapping system to be quick and easy to apply. Still further, it would be useful for the strapping system to allow, in certain instances, reuse of at least some of the taping materials. Such a strapping system would be useful in multiple applications, particularly sport medicine (e.g., athletic training), and orthopedic medicine.

### SUMMARY OF THE INVENTION

In accordance with the present invention, an athletic taping, or strapping, system for securing or supporting a human or animal body part is provided that includes a first layer of a cohesive elastic material, and a second layer of a cohesive non-elastic material. Generally, the first layer contacts the human or animal body part and the second layer substantially covers at least a portion of the first layer so as to provide support.

The invention further includes the method of creating, or employing the strapping system so as to secure and support a human or animal body part. In general, the method involves first wrapping the human or animal body part with a first tape layer of a cohesive elastic material, and then wrapping at least a portion of the wrapped first tape layer with a second tape layer of a cohesive non-elastic material, so as to secure and support the body part.

The invention still further includes kits useful for providing the components of the strapping system. Such strapping system kits of the invention minimally include the essential components of strapping system, namely a cohesive elastic material, and a cohesive non-elastic material. Generally both the cohesive elastic material and the cohesive non-elastic material are supplied as a tape.

Accordingly, the invention includes a strapping system, a method of creating the strapping system and a kit useful for supplying the components of the strapping system. Furthermore, the invention encompasses an array of specific embodiments. In one such embodiment, the strapping system of the invention employs an elastic cohesive material that is a tape which includes a layer that is elastic in the longitudinal direction of the tape. In another embodiment, the elastic layer is laminated to one side of a warp-knitted (weft insertion) fabric oriented with the knit yarns extending longitudinally. In certain embodiments, the elastic layer is laminated between a pair of outer layers, at least one of which is warp-knitted (weft insertion). In particular embodiments, the elastic cohesive material has a longitudinal stretch of at least about 50%. In particularly useful embodiments, the elastic cohesive material has a longitudinal stretch of at least about 80%.

In further embodiments of the strapping system and associated methods and kits of the invention, the cohesive elastic material includes a rubber latex-based cohesive agent. In other embodiments, the cohesive elastic material includes a synthetic water-based cohesive agent. In certain embodiments utilizing synthetic water-based cohesive agents, the synthetic water-based cohesive agent comprises an elastomer having an inherently crystalline structure such as polychloroprene, polyester polyurethane, or polycaprolactone polyurethane. In further embodiments utilizing synthetic water-based cohesive agents, the synthetic water-based cohesive agent further includes at least one tackifying agent in an amount effective to disrupt the crystalline structure of the elastomer in a partial polycrystalline state such that the elastomer possesses a cohesive property.

In particular embodiments, the cohesive elastic material comprises two or more layers laminated together by a binding agent. In further embodiments, the two or more layers of the cohesive elastic material are laminated together by a cohesive agent. In certain embodiments, the elastic tape has a strength of about 20 pounds per inch of width.

In still further embodiments of the strapping system and associated methods and kits of the invention, the non-elastic cohesive material is a tape having two layers of material, each layer having warp yarns extending longitudinally of the tape and weft yarns extending transversely of the tape, the warp yarns being non-elastic, and a layer of nonwoven material positioned between the two layers of material. In certain embodiments, the nonwoven material facilitates hand-tear of the tape. In further embodiments, the non-elastic material has a longitudinal stretch of not more than about 4%. In particularly useful embodiments, the non-elastic material has a longitudinal stretch of not more than about 1% (e.g., a longitudinal stretch of about 0.5%).

In further embodiments of the strapping system and associated methods and kits of the invention, the non-elastic cohesive material includes a rubber latex-based cohesive agent. In other embodiments, the non-elastic cohesive material includes a synthetic water-based cohesive agent. In certain embodiments utilizing synthetic water-based cohesive agents, the synthetic water-based cohesive agent comprises an elastomer having an inherently crystalline structure such as polychloroprene, polyester polyurethane, or polycaprolactone polyurethane. In further embodiments utilizing synthetic water-based cohesive agents, the synthetic water-based cohesive agent further includes at least one tackifying agent in an amount effective to disrupt the crystalline structure of the elastomer in a partial polycrystalline state such that the elastomer possesses a cohesive property.

In still further embodiments of the strapping system and associated methods and kits of the invention, the non-elastic cohesive material includes two or more layers of material laminated together by a binding agent. In particularly useful embodiments, the binding agent is a cohesive agent. In further particularly useful embodiments, the non-elastic material is a tape that is hand-tearable. In other useful embodiments, the non-elastic cohesive material is a tape that has a strength of about 40 pounds per inch of width.

In further useful embodiments of the invention, the human or animal body part that is secured is an ankle, a foot, a leg, a knee, an elbow, a forearm, a wrist, a hand, a shoulder, an arm, a thigh, a hip, or a pelvis. In other useful embodiments of the strapping system and associated methods, the first layer of cohesive elastic material conforms tightly to the body part and to the second layer of overlying cohesive non-elastic material to provide a well-conformed structure that stabilizes and supports the body part. In further embodiments, the first layer of cohesive elastic material includes multiple layers of overlapping cohesive elastic tape wound around the body part. In still further embodiments, the second layer of cohesive non-elastic material includes multiple layers of overlapping cohesive non-elastic tape wound over the first layer of cohesive elastic material.

In an exemplary embodiment, the invention provides an orthopedic or athletic strapping system for securing a human or animal body part that includes two layers, wherein the first layer contacts the human or animal body part and the second layer substantially covers at least a portion of the first layer. In this exemplary embodiment, the first layer is a cohesive elastic tape made up of an elastic layer of longitudinally-extending elastic strands that is laminated between a pair of outer layers, at least one of which outer layers is a warp-knitted (weft insertion) fabric, the layers of the cohesive elastic tape being laminated together and bonded by a cohesive agent that serves as a binder and as an external cohesive. In this exemplary embodiment, the first layer of cohesive elastic tape has a longitudinal stretch of at least about 50%. Further, the second layer is a cohesive non-elastic tape made up of first and second layers of warp-knitted weft-insertion material to facilitate transverse and longitudinal hand tearing of the tape. In this exemplary embodiment, each of these layers has polyester non-elastic warp yarns extending longitudinally of the tape and texturized polyester filament weft yarns extending transversely of the tape. Furthermore, in this exemplary embodiment, the cohesive non-elastic tape further includes a layer of polypropylene spunbonded nonwoven material positioned between the first and second layers of warp-knitted weft-insertion material and the layers of the cohesive non-elastic tape are laminated or bonded together by a cohesive agent that serves as a binder and as an external cohesive. In this exemplary embodiment the cohesive non-elastic tape is hand-tearable and has a longitudinal stretch of not more than about 1%.

### BRIEF DESCRIPTION OF THE FIGURES

FIG. 1 is a drawing of an ankle that has been taped with a first layer of cohesive elastic material 10 and partially taped with an overlying layer of non-elastic cohesive material 20 applied in a so-called stirrup configuration to provide ankle control and support.

FIG. 2 is a drawing of the strapping system applied to a taped wrist, partially broken away along line 2, showing a layer of elastic cohesive tape 10A that has been wrapped around the wrist 4, and which is substantially covered by a layer of non-elastic cohesive tape 20A.

FIG. 3 is a cross-sectional view, taken at line 2-2 of FIG. 2 showing the layer of elastic cohesive tape 10A underwrap that has been wrapped around the wrist 4, seen in cross-section, and surrounded by a layer of non-elastic cohesive tape 20A overwrap.

FIG. 4 is a drawing of an exemplary elastic cohesive tape 10B showing a top view, partially broken away, having a top layer 12 of warp-knitted (weft insertion) fabric, a bottom layer 14 of spun bond nylon nonwoven, and a middle layer of longitudinally-extending, transversely spaced (about 12 per inch) elastic strands 16, the three-layer structure being laminated together by a binder that impregnates all three layers. The cohesive agent is impregnated thoughout all three layers and further serves to bond all three layers together.

FIG. 5 is a drawing of an exemplary non-elastic cohesive tape 20B showing a top view, partially broken away, having a top layer 22 and bottom layer 24, both of which have weft yarns extending transversely of the tape and non-elastic warp yarns which make the tape 20B non-elastic in the longitudinal direction, and also having a middle layer 26 of nonwoven material positioned between layers 22 and 24 that facilitates hand-tearing of the tape. The cohesive agent is impregnated thoughout all three layers and further serves to bond all three layers together.

### DETAILED DESCRIPTION OF THE INVENTION

The invention is based, in part, upon the finding that combining a cohesive elastic underwrap with a cohesive non-elastic overwrap results in an athletic strapping system with particularly desirable properties, including improved performance and durability.

Accordingly, the invention provides an athletic taping, or strapping, system that includes a cohesive elastic material and a cohesive non-elastic material. In general, the cohesive elastic material is applied under the cohesive non-elastic material, i.e. the cohesive elastic material is an underwrap and the cohesive non-elastic material is an overwrap. The underwrap is typically applied to the selected body part first and the overwrap is applied so as to cover all, or a substantial part, of at least a portion of the underwrap. The resulting structure supports and secures the strapped body part. The invention includes an associated method of securing or supporting a body part by employing the strapping system of the invention. In general, the method of use of the invention involves wrapping a human or animal body part with a first cohesive elastic tape layer and then wrapping at least a portion of the wrapped first tape layer with a second tape layer of a cohesive non-elastic material. The resulting system provides support to the strapped body part. In addition, the invention provides a kit supplying a cohesive elastic material and a cohesive non-elastic material. The kit is useful, for example, for conveniently supplying an athletic trainer with the necessary components to strap, or tape, a body part (e.g., to reinforce a body part before an athletic event or to protect an existing injury).

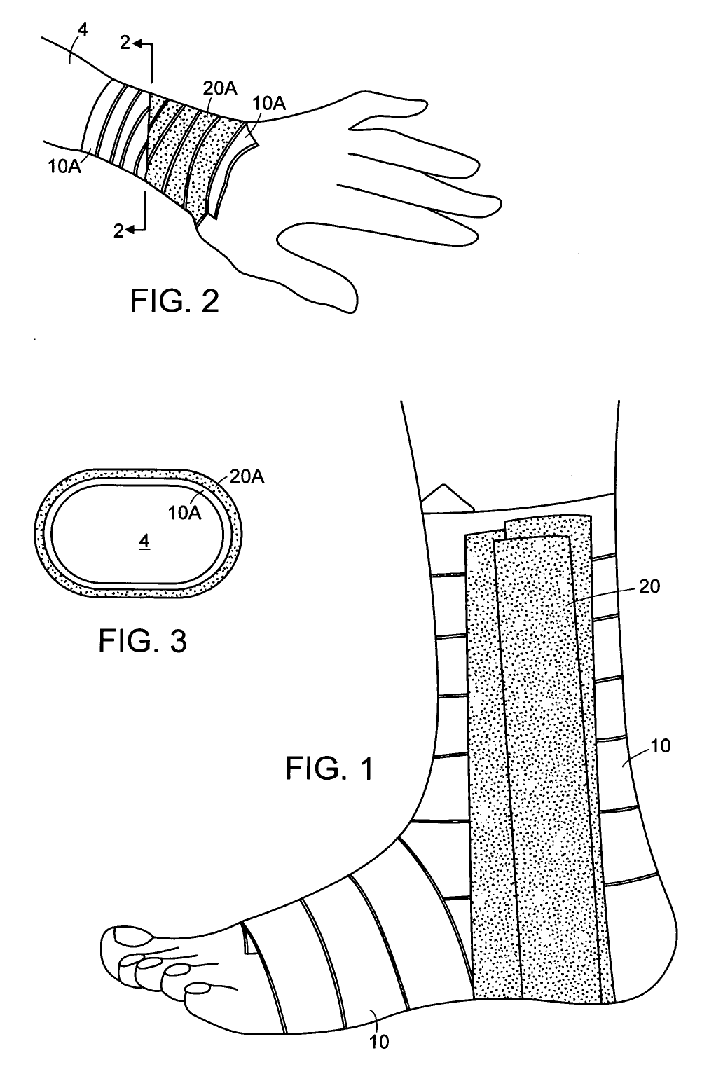

The strapping system provided by the instant invention may be applied to any human or animal body part. Therefore, in various examples, the body part may be an ankle, a foot, a leg, a knee, an elbow, a forearm, a wrist, a hand, a shoulder, an arm, a thigh, a hip, or a pelvis. An example of the strapping system of the invention applied to a human ankle is shown in FIG. 1 and an example of the strapping system of the invention applied to a human wrist is shown in FIG. 2 (and FIG. 3). Furthermore, the strapping system of the invention is adaptable to both human (e.g. sports medicine) and animal (e.g., veterinary) applications.

Typically, the cohesive elastic material is applied directly to the human or animal body part to be strapped, however this underwrap layer may also be applied over a layer of clothing or other light covering. The cohesive elastic material is typically a tape, and the layer of cohesive elastic material is typically applied by wrapping, in an overlapping or non-overlapping pattern having one or more layers, the cohesive elastic tape around the body part to be strapped. Generally, the elastic tape is under tension when wound around the body part so that it provides pressure and support to the body part when in place. This first layer of cohesive elastic material may be wound around the body part multiple times in an overlapping fashion, or applied in nonoverlapping layers. Accordingly, it is understood that the first elastic “layer” may itself be composed of multiple layers of the cohesive elastic material (e.g., assembled by winding multiple layers of a cohesive elastic tape around the body part to be supported). The cohesive property of the elastic underwrap allows it to stick to itself, but not substantially to the body part, or layer of clothing or light covering, to which it is applied. The cohesive property of the elastic underwrap thereby facilitates both the wrapping and the unwrapping process. Furthermore the cohesive property of the elastic underwrap allows it to adhere to the cohesive non-elastic overwrap layer, thereby facilitating the creation of a tightly fitted, compact and coherent strapping system whole.

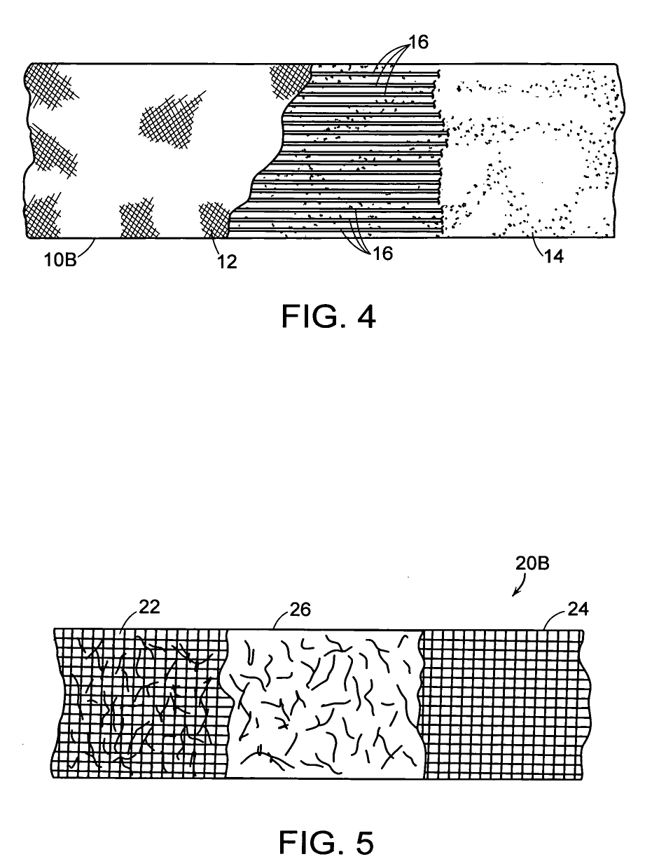

An example of a cohesive elastic tape layer (10) applied to a human ankle is shown in FIG. 1. A portion of this cohesive elastic tape layer underwrap is shown substantially covered by a layer of cohesive non-elastic tape (20), which is shown applied in a “stirrup” pattern to provide lateral support to the ankle joint. Further layers of cohesive non-elastic tape may be applied around the leg and foot portion to provide added support and security to the strapping system. In another example, a cohesive elastic tape layer (10A) is shown applied to a human wrist in FIG. 2. The overlying layer of cohesive non-elastic overwrap (20A), which otherwise substantially covers the cohesive elastic underwrap (10A), is shown beneath the cohesive non-elastic overwrap (20A), in the partially broken away view to the left of line 2. FIG. 3 is a cross-sectional view, taken at line 2-2 of FIG. 2, which shows the relation of layer 10A and 20A to the taped wrist (4). Exemplary cohesive elastic tapes for use in the invention are described in U.S. Pat. No. 5,762,623, the contents of which are hereby incorporated by reference in their entirety. Further specific examples of cohesive elastic tapes for use in the invention are available from Andover Coated Products of Salisbury, Mass. under the registered trademark “PowerFlex” and “CoFlex.” (including “CoFlex-Med” and “CoFlex-NL”). The structure of an exemplary elastic cohesive tape for use in the invention is shown in FIG. 4, and described in the associated figure legend.

Typically, the cohesive non-elastic material is applied over all, or a substantial portion of at least a part, of the cohesive elastic underwrap. The cohesive non-elastic material is typically a tape, and the layer of cohesive non-elastic material is typically applied by wrapping, in an overlapping or non-overlapping pattern having one or more layers, the cohesive non-elastic tape over the cohesive elastic underwrap that has been applied to the subject body part as described above. Generally, the non-elastic overwrap provides a measure of rigidity and support to the elastic underwrap layer. This second layer of cohesive non-elastic material may be wound around the body part multiple times in an overlapping fashion, or applied in nonoverlapping layers. Accordingly, it is understood that the second non-elastic “layer” may itself be composed of multiple layers of the cohesive non-elastic material (e.g., assembled by winding multiple layers of a cohesive non-elastic tape around the body part to be supported). The cohesive property of the non-elastic overwrap allows it to stick to itself, as well as to the underlying cohesive elastic layer. Accordingly the first elastic layer and the second non-elastic layer, each being cohesive and therefore “self-sticky”, conform well to one another to form a tightly fitted, compact and coherent strapping system whole.

An example of a cohesive non-elastic tape layer (20), applied over a layer of cohesive elastic tape (10) is shown applied to a human ankle in FIG. 1. Only a portion of the cohesive elastic tape layer underwrap (10) is shown substantially covered by a layer of overlapping bands of the non-elastic cohesive tape (20), which is shown applied in a “stirrup” pattern that provides lateral support to the ankle joint. Further layers of cohesive non-elastic tape may be applied around the leg and foot portion to provide added support and security to the strapping system. In another example, a cohesive non-elastic tape layer (20A) is shown applied to a human wrist in FIG. 2. This overlying layer of cohesive non-elastic overwrap (20A), which otherwise substantially covers the cohesive elastic underwrap (10A), is cut away, to show the underlying layer of cohesive non-elastic underwrap (10A) beneath, in the partially broken away view to the left of line 2. FIG. 3 is a cross-sectional view, taken at line 2-2 of FIG. 2, which shows the relation of layers 10A and 20A to the strapped wrist (4).

Exemplary cohesive non-elastic tapes for use in the invention are described in co-pending U.S. Ser. No. 10/946,221, filed on Sep. 21, 2004 and entitled “Hand—Tearable Non-Elastic Tape” (Inventor: Mr. Thomas S. Murphy of Salisbury, Mass.), the contents of which are hereby incorporated by reference in their entirety. Particularly useful cohesive non-elastic tapes for use in the invention are structured so that they may be readily torn by hand (i.e., are “hand-tearable”) so as to facilitate the process of taping or strapping.

Suitable hand-tearable non-elastic tapes may include a non-elastic layer of material to facilitate hand tearing of the tape and a nonwoven layer of material laminated thereto. Such tapes generally have a laminated structure that includes two layers of material, each layer having non-elastic warp yarns extending longitudinally of the tape and weft yarns extending transversely of the tape, and a third layer of non-woven material positioned between these first two layers. One or both of the two layers of material that include warp yarns and weft yarns may be a warp-knitted weft-insertion fabric, or a scrim woven fabric. Any combination of these fabrics is possible. For example, one of the two layers of material that include warp yarns and weft yarns may be a warp-knitted weft-insertion fabric, and the other of the two layers of material that includes warp yarns and weft yarns may be a scrim woven fabric. The structure of an exemplary non-elastic cohesive tape for use in the invention is shown in FIG. 5, and described in the associated figure legend.

The warp and/or weft yarns of such suitable hand-tearable non-elastic tapes may be yarns of polyolefin, polyester, polycotton, cotton or any other suitable material. In certain cases, the weft yarns of one or both of the layers of material that include warp yarns and weft yarns may be texturized filament yarns. The warp yarns may be spaced at a density in the range of 12 to 24 yarns per inch measured transversely of the tape. For example, the warp yarns may be spaced at a density of about 18 yarns per inch measured transversely of the tape. The warp yarns may have a denier in the range of 30 to 80. For example the warp yarns may have a denier of about 50 or about 40. The weft yarns may be spaced at a density in the range of 9 to 18 yarns per inch measured longitudinally of the tape. For example, the weft yarns may be spaced at a density of about 12 yarns per inch measured longitudinally of the tape. In certain examples, the weft yarns may have a denier in the range of 50 to 200. For example the weft yarns may have a denier of about 150 or about 70.

In certain examples of such a laminated, hand-tearable non-elastic cohesive tape for use in the invention, each layer of the two layers of material that include warp yarns and weft yarns may have a weight of not more than about 1.5 ounces per square yard. For example, each layer may have a weight in the range of 0.3 to 0.5 ounces per square yard. Furthermore, the warp yarns of at least one of the two layers of material may include a plurality of longitudinally-spaced knitted loops that each include three yarn portions, and the weft yarns of the layer or layers of material may extend transversely of the tape through the loops of the warp yarns.

As described above, exemplary laminated, hand-tearable non-elastic cohesive tapes for use in the invention include a nonwoven layer of material. The nonwoven layer of the laminated tape may be a synthetic spunbonded nonwoven material, and may have a weight of no more than about 1.0 ounce per square yard (e.g., the nonwoven material may have a weight in the range of 0.3 to 0.5 ounces per square yard). In certain examples, the nonwoven material may be a synthetic spunbonded nonwoven material such as, for example, nylon, polyester, polypropylene, rayon, or any other suitable material, and may have a weight of not more than about 0.3 ounces per square yard.

In certain instances, the laminated non-elastic cohesive tape may include a binder bonding the layers together. The binder is typically applied by impregnating each of the layers of the laminated tape. Further, the binder may be, for example, a cohesive agent (although an adhesive agent may be used as the binder, and a cohesive agent later applied to the bound laminated tape layer to give the tape an overall outwardly cohesive character). Exemplary cohesive binding agents latex-based cohesive agents such as a natural rubber latex-based cohesive agent. Alternatively, in embodiments in which the binder is a cohesive agent, the binder may be a synthetic water-based cohesive agent. The synthetic water-based cohesive agent may include, for example, an elastomer having an inherently crystalline structure (e.g., polychloroprene, polyester polyurethane, polycaprolactone polyurethane, etc.), and include at least one tackifying agent in an amount effective to disrupt the crystalline structure of the elastomer in a partial polycrystalline state such that the elastomer possesses a cohesive property. Exemplary water-based cohesive agents are described in U.S. Pat. No. 6,156,424, as discussed further below.

In particularly useful examples of non-elastic cohesive tapes for use in the invention, the laminated layers of material may yield a tensile strength in the range of 30 to 60 pounds per inch. For example, the laminated layers of material may yield a tensile strength of about 40 pounds per inch (e.g., a tensile strength of about 20 pounds per inch). In one particularly useful example, one of the two layers of material that include warp yarns and weft yarns has a tensile strength of about 18 pounds per inch, the other has a tensile strength of about 22 pounds per inch, and the resulting laminated non-elastic tape has a tensile strength of about 40 pounds per inch (the strength of nonwoven layer alone not generally contributing significantly to the strength of the overall laminated tape.

Suitable cohesive agents for use in the elastic and non-elastic materials of the invention include latex-based cohesive agent such as, for example, a natural rubber latex-based cohesive agent. A natural rubber latex-based cohesive agent may contain a mixture of natural rubber modified with tackifying resins and pigments. The cohesive agent may also be a synthetic water-based cohesive agent (e.g., in applications in which a latex-free product is desired). Examples of synthetic water-based cohesive agents are described, for example, in commonly-assigned Taylor U.S. Pat. No. 6,156,424 (“the Taylor patent”), which is hereby incorporated by reference herein in its entirety. As described in the Taylor patent, a synthetic water-based cohesive agent may include an elastomer having an inherently crystalline structure and at least one tackifying agent in an amount effective to disrupt the crystalline structure of the elastomer in a partial polycrystalline state such that the elastomer possesses a cohesive property. Such an elastomer may include, for example, polychloroprene, polyester polyurethane, or polycaprolactone polyurethane. As mentioned above in the description of a particularly useful non-elastic cohesive tape for use in the invention, both the latex- and non-latex-based cohesive agents may be used as a binder to bind together multiple layers of laminated elastic tapes, as well as laminated non-elastic tapes, in addition to being used as the outward cohesive agent providing the overall cohesive character to the elastic and non-elastic materials.

It will be understood that the foregoing is only illustrative of the principles of the present invention, and that still other modifications can be made by those skilled in the art without departing from the scope and spirit of the invention. For example, the various materials mentioned herein are only examples, and other materials possessing similar properties can be used, if desired.

What is claimed is:

1. An orthopedic or athletic strapping system for securing a human or animal body part comprising
a first layer of a cohesive elastic material, and
a second layer of a cohesive non-elastic material,
wherein the first layer is placed over the human or animal body part and the second layer substantially covers at least a portion of the first layer.

2. The strapping system of claim 1, wherein the elastic material is a tape that comprises a layer that is elastic in the longitudinal direction of the tape.

3. The strapping system of claim 2, wherein the elastic layer is laminated to one side of a warp-knitted (weft insertion) fabric oriented with the knit yarns extending longitudinally.

4. The strapping system of claim 3, wherein the elastic layer is laminated between a pair of outer layers, at least one of which is warp-knitted (weft insertion).

5. The strapping system of claim 1, wherein the elastic material has a longitudinal stretch of at least about 50%.

6. The strapping system of claim 1, wherein the elastic material has a longitudinal stretch of at least about 80%.

7. The strapping system of claim 1, wherein the cohesive elastic material comprises a rubber latex-based cohesive agent.

8. The strapping system of claim 1, wherein the cohesive elastic material comprises a synthetic water-based cohesive agent.

9. The strapping system of claim 8, wherein the synthetic water-based cohesive agent comprises an elastomer having an inherently crystalline structure and selected from the group consisting of polychloroprene, polyester polyurethane, and polycaprolactone polyurethane, and
at least one tackifying agent in an amount effective to disrupt the crystalline structure of the elastomer in a partial polycrystalline state such that the elastomer possesses a cohesive property.

10. The strapping system of claim 1, wherein the cohesive elastic layer comprises two or more layers laminated together by a binding agent.

11. The strapping system of claim 10, wherein the binding agent is a cohesive agent.

12. The strapping system of claim 2, wherein the elastic tape has a strength of about 20 pounds per inch of width.

13. The strapping system of claim 1, wherein the non-elastic material is a tape comprising
two layers of material, each layer comprising warp yarns extending longitudinally of the tape and weft yarns extending transversely of the tape, wherein the warp yarns are non-elastic; and
a layer of nonwoven material positioned between the two layers of material.

14. The strapping system of claim 13, wherein the nonwoven material positioned between the two layers of warp-knitted weft-insertion material facilitates hand-tear.

15. The strapping system of claim 1, wherein the non-elastic material has a longitudinal stretch of not more than about 4%.

16. The strapping system of claim 1, wherein the non-elastic material has a longitudinal stretch of not more than about 1%.

17. The strapping system of claim 1, wherein the non-elastic material has a longitudinal stretch of about 0.5%.

18. The strapping system of claim 1, wherein the cohesive non-elastic material comprises a rubber latex-based cohesive agent.

19. The strapping system of claim 1, wherein the cohesive non-elastic material comprises a synthetic water-based cohesive agent.

20. The strapping system of claim 19, wherein the synthetic water-based cohesive agent comprises
an elastomer having an inherently crystalline structure and selected from the group consisting of polychloroprene, polyester polyurethane, and polycaprolactone polyurethane, and
at least one tackifying agent in an amount effective to disrupt the crystalline structure of the elastomer in a partial polycrystalline state such that the elastomer possesses a cohesive property.

21. The strapping system of claim 1, wherein the cohesive non-elastic material comprises two or more layers laminated together by a binding agent.

22. The strapping system of claim 21, wherein the binding agent is a cohesive agent.

23. The strapping system of claim 1, wherein the non-elastic material is a tape that is hand-tearable.

24. The strapping system of claim 1, wherein the non-elastic material is a tape that has a strength of about 40 pounds per inch of width.

25. The strapping system of claim 1, wherein the human or animal body part secured is selected from the group consisting of: an ankle, a foot, a leg, a knee, an elbow, a forearm, a wrist, a hand, a shoulder, an arm, a thigh, a hip, and a pelvis.

26. The strapping system of claim 1, wherein the first layer of cohesive elastic material conforms tightly to the body part and to the second layer of cohesive non-elastic material to provide a well-conformed structure that stabilizes and supports the body part.

27. The strapping system of claim 1, wherein the first layer of cohesive elastic material comprises multiple layers of overlapping cohesive elastic tape wrapped around the body part.

28. The strapping system of claim 1, wherein the second layer of cohesive non-elastic material comprises multiple layers of overlapping cohesive non-elastic tape wrapped over the first layer of cohesive elastic material.

29. An orthopedic or athletic strapping system for securing a human or animal body part comprising:
a first layer of a cohesive elastic tape, wherein the cohesive elastic tape comprises an elastic layer of longitudinally-extending elastic strands that is laminated between a pair of outer layers, at least one of which outer layers is a warp-knitted (weft insertion) fabric, the layers of the cohesive elastic tape being laminated together and bonded by a cohesive agent that serves as a binder and as an external cohesive, and further wherein the cohesive elastic tape has a longitudinal stretch of at least about 50%; and
a second layer of a cohesive non-elastic tape, wherein the cohesive non-elastic tape comprises first and second layers of warp-knitted weft-insertion material to facilitate transverse and longitudinal hand tearing of the tape, each layer comprising polyester non-elastic warp yarns extending longitudinally of the tape and texturized polyester filament weft yarns extending transversely of the tape, and a layer of polypropylene spunbonded nonwoven material positioned between the first and second layers of warp-knitted weft-insertion material, the layers of the non-cohesive elastic tape being laminated and bonded together by a cohesive agent that serves as a binder and as an external cohesive, and further wherein the cohesive non-elastic tape is hand-tearable and has a longitudinal stretch of not more than about 4%,
wherein the first layer contacts the human or animal body part and the second layer substantially covers at least a portion of the first layer.

30. The orthopedic or athletic strapping system of claim 29, wherein the cohesive elastic tape has a longitudinal stretch of at least about 80%.

31. The orthopedic or athletic strapping system of claim 29, wherein the cohesive non-elastic tape has a longitudinal stretch of not more than about 1%.

32. The orthopedic or athletic strapping system of claim 29, wherein the cohesive non-elastic tape has a longitudinal stretch of not more than about 0.5%.

33. A strapping system kit comprising:
a first layer material that is a cohesive elastic material; and
a second layer material that is a cohesive non-elastic material.

34. The kit of claim 33, wherein the elastic material is a tape that comprises a layer that is elastic in the longitudinal direction of the tape.

35. The kit of claim 34, wherein the elastic layer is laminated to one side of a warp-knitted (weft insertion) fabric oriented with the knit yarns extending longitudinally.

36. The kit of claim 35, wherein the elastic layer is laminated between a pair of outer layers, at least one of which is warp-knitted (weft insertion).

37. The kit of claim 33, wherein the elastic material has a longitudinal stretch of at least about 50%.

38. The kit of claim 33, wherein the elastic material has a longitudinal stretch of at least about 80%.

39. The kit of claim 33, wherein the cohesive elastic material comprises a rubber latex-based cohesive agent.

40. The kit of claim 33, wherein the cohesive elastic material comprises a synthetic water-based cohesive agent.

41. The kit of claim 40, wherein the synthetic water-based cohesive agent comprises an elastomer having an inherently crystalline structure and selected from the group consisting of polychloroprene, polyester polyurethane, and polycaprolactone polyurethane, and
at least one tackifying agent in an amount effective to disrupt the crystalline structure of the elastomer in a partial polycrystalline state such that the elastomer possesses a cohesive property.

42. The kit of claim 33, wherein the cohesive elastic layer comprises two or more layers laminated together by a binding agent.

43. The kit of claim 42, wherein the binding agent is a cohesive agent.

44. The kit of claim 34, wherein the elastic tape has a strength of about 20 pounds per inch of width.

45. The kit of claim 33, wherein the non-elastic material is a tape comprising two layers of material, each layer comprising warp yams extending longitudinally of the tape and weft yarns extending transversely of the tape, wherein the warp yarns are non-elastic; and a layer of nonwoven material positioned between the two layers of material.

46. The kit of claim 34, wherein the nonwoven material positioned between the two layers of warp-knitted weft-insertion material facilitates hand-tear.

47. The kit of claim 33, wherein the non-elastic material has a longitudinal stretch of not more than about 4%.

48. The kit of claim 33, wherein the non-elastic material has a longitudinal stretch of not more than about 1%.

49. The kit of claim 33, wherein the non-elastic material has a longitudinal stretch of about 0.5%.

50. The kit of claim 33, wherein the cohesive non-elastic material comprises a rubber latex-based cohesive agent.

51. The kit of claim 33, wherein the cohesive non-elastic material comprises a synthetic water-based cohesive agent.

52. The kit of claim 51, wherein the synthetic water-based cohesive agent comprises an elastomer having an inherently crystalline structure and selected from the group consisting of polychloroprene, polyester polyurethane, and polycaprolactone polyurethane, and at least one tackifying agent in an amount effective to disrupt the crystalline structure of the elastomer in a partial polycrystalline state such that the elastomer possesses a cohesive property.

53. The kit of claim 33, wherein the cohesive non-elastic material comprises two or more layers laminated together by a binding agent.

54. The kit of claim 53, wherein the binding agent is a cohesive agent.

55. The kit of claim 33, wherein the non-elastic material is a tape that is hand-tearable.

56. The kit of claim 33, wherein the non-elastic material is a tape that has a strength of about 40 pounds per inch of width.

57. The kit of claim 33, further comprising instructions for wrapping a human or animal body part secured selected from the group consisting of: an ankle, a foot, a leg, a knee, an elbow, a forearm, a wrist, a hand, a shoulder, an arm, a thigh, a hip, and a pelvis.

58. The kit of claim 33, further comprising instructions for wrapping the first layer of cohesive elastic material around a body part and for wrapping the second layer of cohesive non-elastic material around at least a portion of the first wrapped layer.

59. A method of securing and supporting a human or animal body part comprising:
wrapping the human or animal body part with a first tape layer of a cohesive elastic material; and
wrapping at least a portion of the wrapped first tape layer with a second tape layer of a cohesive non-elastic material,
thereby securing and supporting the human or animal body part.

60. The method of claim 59, wherein the elastic material is a tape that has a longitudinal stretch of at least about 50%.

61. The method of claim 59, wherein the elastic material is a tape that has a longitudinal stretch of at least about 80%.

62. The method of claim 59, wherein the cohesive elastic material comprises a rubber latex-based cohesive agent.

63. The method of claim 59, wherein the cohesive elastic material comprises a synthetic water-based cohesive agent.

64. The method of claim 63, wherein the synthetic water-based cohesive agent comprises an elastomer having an inherently crystalline structure and selected from the group consisting of polychloroprene, polyester polyurethane, and polycaprolactone polyurethane, and at least one tackifying agent in an amount effective to disrupt the crystalline structure of the elastomer in a partial polycrystalline state such that the elastomer possesses a cohesive property.

65. The method of claim 60, wherein the elastic tape has a strength of about 20 pounds per inch of width.

66. The method of claim 59, wherein the non-elastic material is a tape comprising two layers of material, each layer comprising warp yarns extending longitudinally of the tape and weft yarns extending transversely of the tape, wherein the warp yarns are non-elastic; and a layer of nonwoven material positioned between the two layers of material.

67. The method of claim 66, wherein the nonwoven material positioned between the two layers of warp-knitted weft-insertion material facilitates hand-tear.

68. The method of claim 59, wherein the non-elastic material has a longitudinal stretch of not more than about 4%.

69. The method of claim 59, wherein the non-elastic material has a longitudinal stretch of not more than about 1%.

70. The method of claim 59, wherein the non-elastic material has a longitudinal stretch of not more than about 0.5%.

71. The method of claim 59, wherein the cohesive non-elastic material comprises a rubber latex-based cohesive agent.

72. The method of claim 59, wherein the cohesive non-elastic material comprises a synthetic water-based cohesive agent.

73. The method of claim 72, wherein the synthetic water-based cohesive agent comprises an elastomer having an inherently crystalline structure and selected from the group consisting of polychloroprene, polyester polyurethane, and polycaprolactone polyurethane, and at least one tackifying agent in an amount effective to disrupt the crystalline structure of the elastomer in a partial polycrystalline state such that the elastomer possesses a cohesive property.

74. The method of claim 59, wherein the non-elastic material is a tape that is hand-tearable.

75. The method of claim 59, wherein the non-elastic material is a tape that has a strength of about 40 pounds per inch of width.

75. The method of claim 59, wherein the human or animal body part secured is selected from the group consisting of: an ankle, a foot, a leg, a knee, an elbow, a forearm, a wrist, a hand, a shoulder, an arm, a thigh, a hip, and a pelvis.

76. The method of claim 59, wherein the first layer of cohesive elastic material conforms tightly to the body part and to the second layer of cohesive non-elastic material to provide a well-conformed structure that stabilizes and supports the body part.

77. The method of claim 59, wherein the body part is wrapped with multiple overlapping layers of the first layer of cohesive elastic material.

78. The method of claim 59, wherein the first layer of cohesive elastic material is wrapped with multiple overlapping layers of the second layer of cohesive non-elastic material.
